(19) United States
(12) Patent Application Publication
(10) Pub. No.: US 2025/0200607 A1
(43) Pub. Date: Jun. 19, 2025

(54) SYSTEMS AND METHODS FOR AN AI-BASED CONTENT PLATFORM

(71) Applicant: YAHOO ASSETS LLC, New York, NY (US)

(72) Inventor: Bishwajit AICH, Milpitas, CA (US)

(21) Appl. No.: 18/539,428

(22) Filed: Dec. 14, 2023

(51) Int. Cl. G06Q 30/0251

(52) U.S. Cl. CPC G06Q 30/0254

(57) ABSTRACT

Disclosed are systems and methods that provide a decision-intelligence (DI)-based, computerized framework for demand-side platforms (DSPs) to effectively plan, launch, optimize and monitor the performance of content campaigns over a network on network resources. The disclosed framework operates to perform strategic and data-driven processes for DSP initiatives that can define campaign parameters, and in real-time, monitor the effectiveness of campaigns such that their modifications and/or alterations can be dynamically performed so as to adapt to the changing landscapes of how the campaign is being disseminated over a network and received by users. The framework can implement AI/ML and/or LLM models and functionality to provide DSPs with comprehensive tools for managing, curating and analyzing content related to content campaigns for optimal and accurate performance and impact.

### FIELD OF THE DISCLOSURE

The present disclosure is generally related to content generation and delivery, and more particularly, to a decision intelligence (DI)-based computerized framework for deterministically performing monitoring, curation and generation of digital content that constitutes content campaigns that are implemented over a computer network.

### SUMMARY OF THE DISCLOSURE

According to some embodiments, the disclosed systems and methods provide novel artificial intelligence (AI)-based mechanisms for demand-side platforms (DSPs) to effectively plan, launch, optimize and monitor the performance of content campaigns. As discussed herein, the disclosed systems and methods are realized via a provided computerized framework that operates to perform strategic and data-driven processes for DSP initiatives. Accordingly, in some embodiments, the DSP can be associated with and/or part of a content delivery platform (CDP) (e.g., Yahoo!®).

According to some embodiments, as discussed herein, the disclosed framework can provide DSPs with functionality and capabilities related to understanding a campaign's availability, reach and predicted performance given a targeted audience. The audience can include, but is not limited to, a set or type of users, topics, categories, time periods, products, services, items, geography, demographics, and the like, or some combination thereof.

According to some embodiments, the disclosed framework can determine and/or define campaign objectives that can encompass goals, such as, but not limited to, brand awareness, website traffic, conversions, and the like. In some embodiments, the disclosed framework can identify and/or determine the target audience by leveraging a range of parameters such as, but not limited to, demographics, interests, behavior, location and devices, and the like. Further, in some embodiments, a choice of content/campaign formats can be determined, which can include, but are not limited to, display, video, native, and the like. Moreover, in some embodiments, budget and bid strategies can be determined, which can be respective to models including, but not limited to, cost per mille (CPM), cost per click (CPC), cost per acquisition (CPA), and the like.

Accordingly, as discussed herein, the disclosed framework's mechanisms are implemented for new and/or existing campaigns, across various platforms and/or websites, in order to optimize visibility while increasing user experience, which can benefit both the campaign provider as well as the targeted audience.

Indeed, in some embodiments, AI and/or machine learning (ML) models can provide critical functionality in enhancing the efficiency and effectiveness of DSP-managed content campaigns. Such AI/ML models can analyze vast datasets to identify patterns, predict user behavior and optimize targeting parameters, inter alia. For example, through ML algorithms, DSPs can automate bid adjustments in real-time based on historical performance data, improving the impression opportunities of reaching the desired audience at the right cost. Additionally, AI-driven optimization can dynamically adjust campaign elements, such as, but not limited to, ad creatives, placements, and targeting to maximize performance.

According to some embodiments, reference to a content campaign (e.g., advertising campaign), as discussed herein, involves a range of technical considerations. As determined, defined and/or controlled by DSPs, ad formats (e.g., display, video and/or native ads), ad channels, targeting parameters, target audience (e.g., demographics, interests, geographics, and the like), keyword optimization, tracking tools and analytics, budgeting and compliance, and the like, or some combination thereof, can be tailored to campaign objectives. Accordingly, the content campaign can correlate to and/or indicate a goal or an intent, which can be associated with a type of audience, an intended audience, and/or a time period, geographic area and/or form or type of content, among other parameters defined by the campaign.

Accordingly, in some embodiments, the disclosed framework can leverage a large language model (LLM) to seamlessly extract and leverage relevant information from electronic resources (e.g., websites, webpages, applications, portals, data repositories, a cloud, and the like). As discussed herein, implementation of an LLM (and/or any other form of AI/ML model) can generate extraction requests that can be dynamically executed and updated, which can enable the framework to focus on contextual and/or topical aspects of categories of data. This, as evidenced from the below discussion, can provide mechanisms for DSPs to harness. Thus, rather than leveraging generic tools and/or manual “tweaking” to obtain data about a topic or category (e.g., a taxonomy) and/or its performance, as with conventional systems, the disclosed systems and methods provide novel technicality that can optimize, in a dynamic manner, how content campaigns can be implemented, thereby increasing their accuracy and improving how efficiently DSPs curate and implement such information on and/or over a network.

The latest versions of LLMs have, among other features and capabilities, theory of mind, abilities to reason, abilities to make a list of tasks, abilities to plan and react to changes (via reviewing their own previous decisions), abilities to understand multiple data sources (and types of data-multimodal), abilities to have conversations with humans in natural language, abilities to adjust, abilities to interact with and/or control application program interfaces (APIs), abilities to remember information long term, abilities to use tools (e.g., read multiple schedules/calendars, command other systems, search for data, and the like), abilities to use other LLM and other types of AI/ML (e.g., neural networks to look for patterns, recognize humans, pets, and the like, for example), abilities to improve itself, abilities to correct mistakes and learn using reflection, and the like.

Thus, as provided herein, the disclosed integration of such LLM technology, as well as known or to be known AI/ML models, to execute the disclosed content generation and delivery mechanisms discussed herein provides an improved system that can enable the creation of new ways of serving digital content, while reaching an expanded set of users, inter alia.

According to some embodiments, a method is disclosed for a DI-based computerized framework for DSPs to deterministically perform monitoring, curation and generation of digital content that constitutes content campaigns that are implemented over a computer network. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for deterministically performing monitoring, curation and generation of digital content that constitutes content campaigns that are implemented over a computer network.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

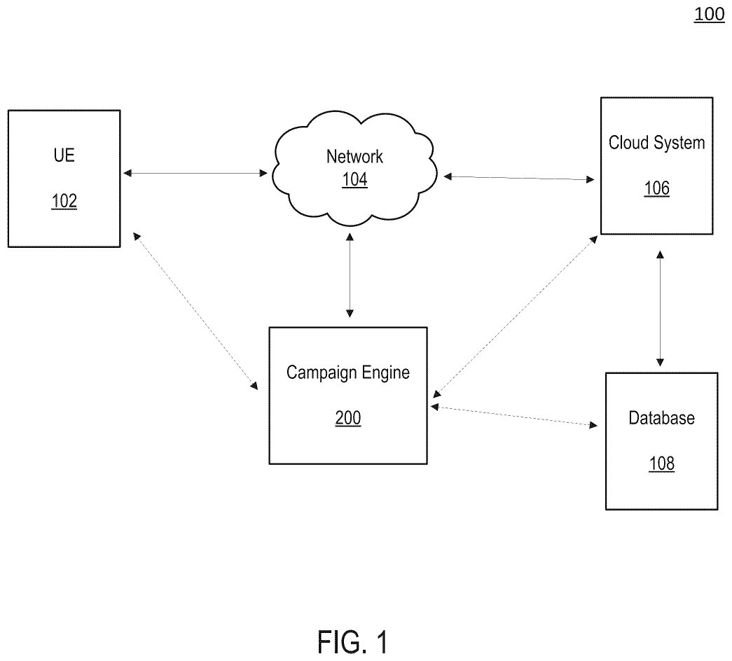

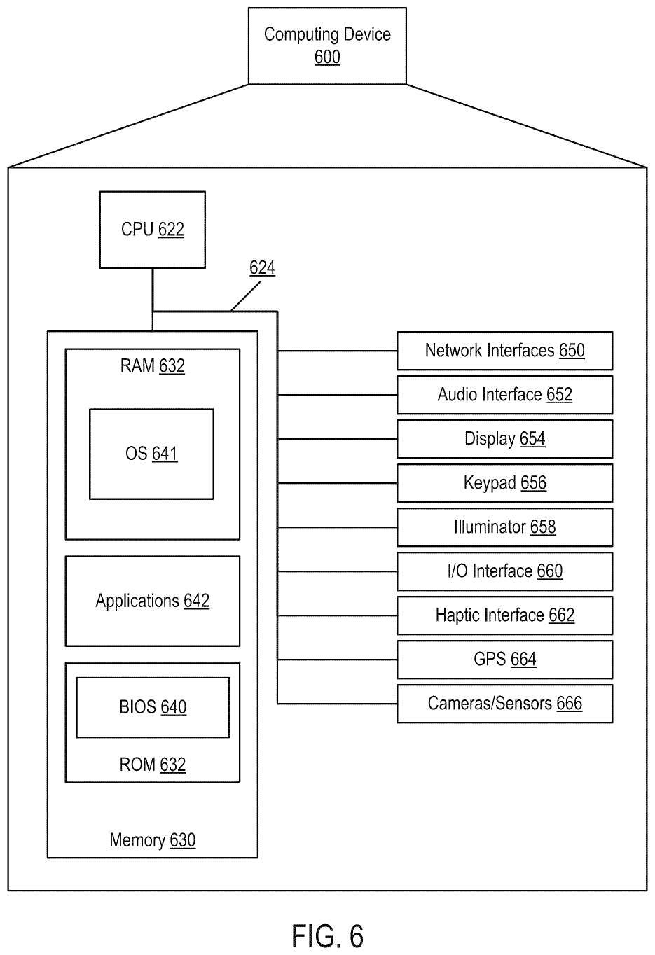

Certain embodiments and principles will be discussed in more detail with reference to the figures. With reference to FIG. 1, system 100 is depicted which includes user equipment (UE) 102 (e.g., a client device, as mentioned above and discussed below in relation to FIG. 6), network 104, cloud system 106, database 108, and campaign engine 200. It should be understood that while system 100 is depicted as including such components, it should not be construed as limiting, as one of ordinary skill in the art would readily understand that varying numbers of UEs, peripheral devices, cloud systems, databases, network resources, engines and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, Internet of Things (IoT) device, autonomous machine, and any other device equipped with a cellular or wireless or wired transceiver. For example, UE 102 can be associated with a device on network 104, which is performing operations for generating and communicating an ad campaign, inclusive of the digital objects that make up the campaign, that will be delivered to other UEs on the network.

In some embodiments, a peripheral device (not shown) can be connected to UE 102, and can be any type of peripheral device, such as, but not limited to, a wearable device (e.g., smart watch), printer, speaker, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a network platform (e.g., Yahoo!®), which has associated network resources hosted on the internet or private network (e.g., network 104), which enables (via engine 200) the campaign management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE, and the services and applications provided by cloud system 106 and/or campaign engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

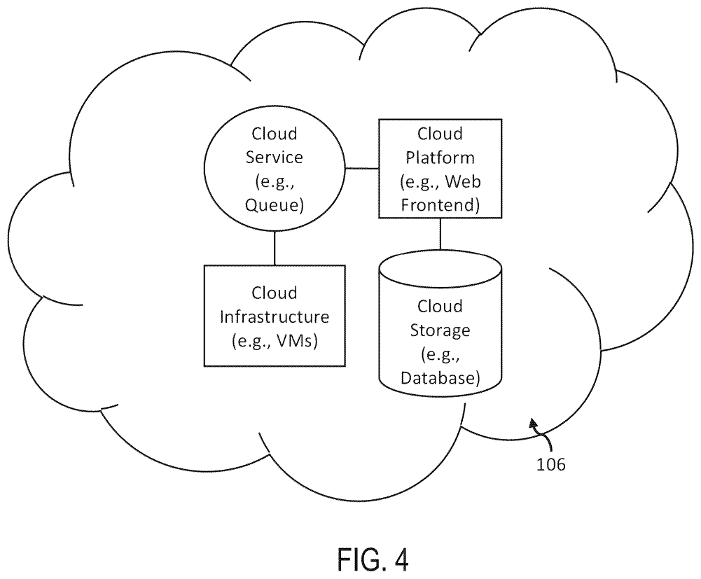

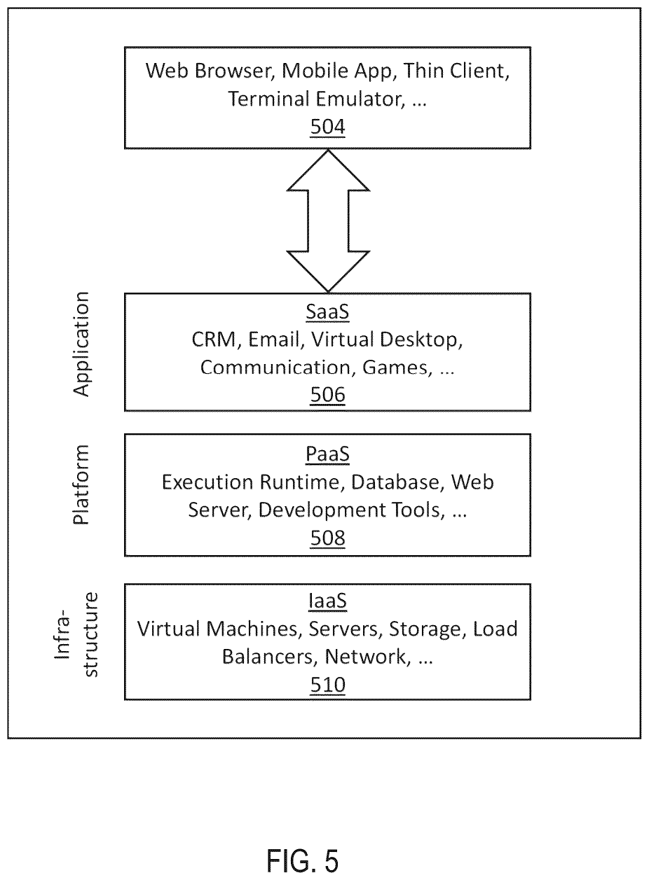

Turning to FIG. 4 and FIG. 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 510, platform as a service (PaaS) 508, and/or software as a service (SaaS) 506 using a web browser, mobile app, thin client, terminal emulator or other endpoint 504. FIG. 4 and FIG. 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Campaign engine 200, as discussed above and further below in more detail, can include components for the disclosed functionality. According to some embodiments, campaign engine 200 may be a special purpose machine or processor, and can be hosted by a device on network 104, within cloud system 106, and/or on UE 102. In some embodiments, engine 200 may be hosted by a server and/or set of servers associated with cloud system 106.

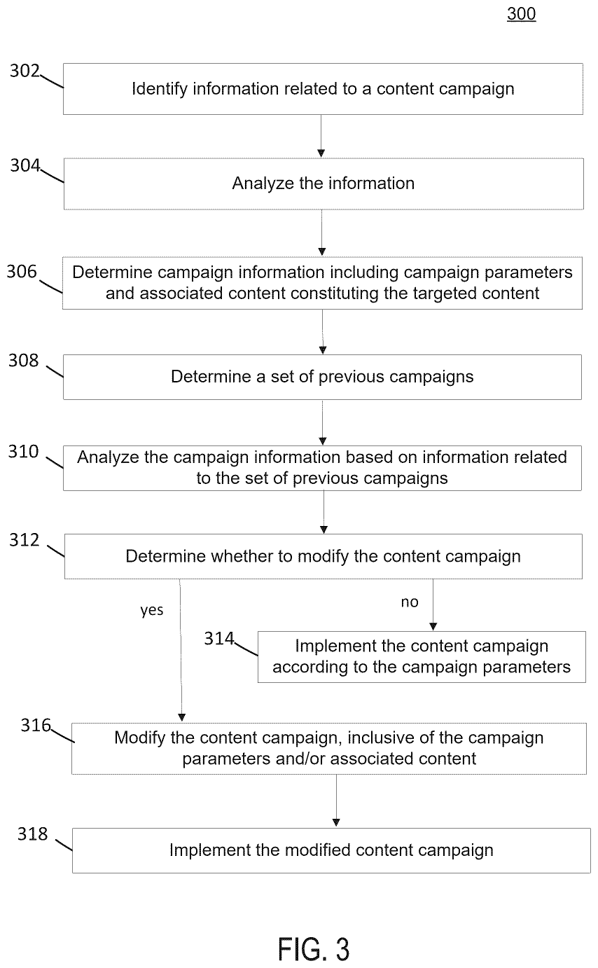

According to some embodiments, as discussed in more detail below, campaign engine 200 may be configured to implement and/or control a plurality of services and/or microservices, where each of the plurality of services/microservices are configured to execute a plurality of workflows associated with performing the disclosed campaign management. Non-limiting embodiments of such workflows are provided below in relation to at least FIG. 3.

According to some embodiments, as discussed above, campaign engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102. In some embodiments, such application may be a web-based application accessed by UE 102 over network 104 from cloud system 106. In some embodiments, engine 200 may be configured and/or installed as an augmenting script, program or application (e.g., a plug-in or extension) to another application or program provided by cloud system 106 and/or executing on UE 102.

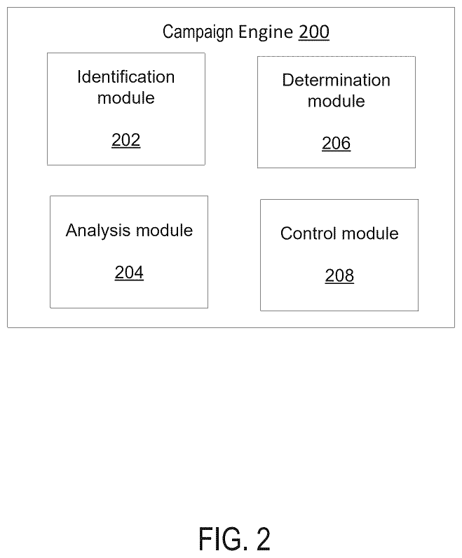

As illustrated in FIG. 2, according to some embodiments, campaign engine 200 includes identification module 202, analysis module 204, determination module 206 and control module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

Turning to FIG. 3, Process 300 provides non-limiting example embodiments for the disclosed content generation and delivery framework. As provided below, the disclosed framework's configuration and implementation can provide a computerized suite of DSP tools for managing content (e.g., advertisement) campaigns and the digital content included therein.

According to some embodiments, as discussed herein, the disclosed framework can enable DSPs to understand the goals and/or intent of advertisers (e.g., third party entities) in terms of campaign (or targeting) parameters, such as, but not limited to, geography, context, sentiment, and the like, for the purpose of reaching the correct audience, both efficiently and accurately. As discussed below, the disclosed framework can function by leveraging past content campaign data, via AI/ML and/or LLM mechanisms, which can enable the setup, modification and/or navigation of campaigns to the proper audience. This, among other benefits, can increase the performance of the campaigns, while also increasing the user experience in receiving information that is of interest and applicable to their objectives.

By way of a non-limiting example, a campaign with a goal of users installing an application would be optimally tailored to users when they are connected to a Wi-Fi network rather than a cellular connection. Thus, campaigns can be tailored to users based on criteria inclusive of, but not limited to, their location, network connectivity, current and/or prediction activity, device-types, and the like, or some combination thereof. Thus, data sets of target audiences can be compiled, which can be leveraged at optimal times and/or locations, as well as based on detected events, to facilitate conversions of ads within such campaigns.

According to some embodiments, Step 302 of Process 300 can be performed by identification module 202 of campaign engine 200; Steps 304 and 310 can be performed by analysis module 204; Steps 306, 308 and 312 can be performed by determination module 206; and Steps 314-318 can be performed by control module 208.

According to some embodiments, Process 300 begins with Step 302 where engine 200 can identify information related to a content (e.g., advertisement) campaign. According to some embodiments, the content campaign can be understood as an electronic data structure or set of data structures that are coordinated to execute computerized promotional activities over a network related to the generation, manipulation and/or delivery of specified forms of digital content.

According to some embodiments, executing a content campaign (over a network, for example, the Internet) involves a range of technical considerations. As determined, defined and/or controlled by DSPs, ad formats (e.g., display, video and/or native ads), ad channels, targeting parameters, target audience (e.g., demographics, interests, geographics, and the like), keyword optimization, tracking tools and analytics, budgeting and compliance, and the like, or some combination thereof, can be tailored to campaign objectives. Accordingly, the content campaign can correlate to and/or indicate a goal or an intent, which can be associated with a type of audience, an intended audience, and/or a time period, geographic area and/or form or type of content, among other parameters defined by the campaign.

In some embodiments, the campaign identified in Step 302 can be a new campaign (e.g., one not yet launched), and in some embodiments, the campaign can be a campaign that has already been launched, and is currently subject to critical the analyses discussed herein.

In Step 304, engine 200 can analyze the information from Step 302, and in Step 306, determine campaign information based therefrom, which can correspond to, but are not limited to, the campaign, predicted user actions in response to the campaign and involved products (or services) for which the campaign is based. Such campaign information can include content campaign parameters and/or associated content constituting the targeted content. As discussed above, the parameters can include, but not be limited to, ad format, ad channels, targeted audience information (e.g., types of users, time periods, geography, demographics, and the like), and the like. The content constituting the targeted content can include, but not be limited to, the media included as the advertisements, which can include, but is not limited to, text, images, videos, multi-media, applications, hyperlinks, and the like, and/or any other type of known or to be known interactive media object capable of providing targeted, third party content.

According to some embodiments, Step 304 can involve engine 200 analyzing the information related to the content campaign, which can involve engine 200 executing a specific trained AI/ML model, a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may leverage an LLM, whether known or to be known. As discussed above, an LLM is a type of AI system designed to understand and generate human-like text based on the input it receives. The LLM can implement technology that involves deep learning, training data and natural language processing (NLP). Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. This includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, engine 200 may be configured to utilize one or more AI/ML techniques selected from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

Thus, in Step 306, based on the analysis from Step 304, engine 200 can determine the campaign information that ultimately captures the intent of the campaign. As discussed herein, the campaign information can include information, as determined from the AI/ML and/or LLM processing via engine 200, related, but not limited to, creative elements (e.g., media type, media format and the like), digital platforms, user actions, timeline and scheduling, consistency, planning and buying, campaign objectives, and the like, or some combination thereof. Accordingly, the campaign information can be stored in database 108, as discussed above.

In Step 308, a set of previous campaigns can be determined or identified. Such determination and/or identification can be executed by engine 200 searching for stored campaign data related to similar types of campaigns, and utilizing such information to identify campaigns that relate (at least to a threshold similarity) to the current campaign. In some embodiments, the AI/ML and/or LLM tools discussed above can be configured to leverage training data, such as past facet data, to identify such campaign data.

In Step 310, engine 200 can analyze the campaign information (from Step 306) based on the information related to the set of previous campaigns (from Step 308). According to some embodiments, such analysis, as discussed herein, can involve and/or be based on information related to, but not limited to, the set of previous campaigns, the present campaign, and the performance of the present campaign (e.g., current performance, predicted and/or historical over a predetermined period of time, which can be compared to a campaign goal), and the like, or some combination thereof. Such analysis can result in a score (or valuation) for the current campaign (from Step 302), which can be compared against a score threshold to determine whether or not to modify the campaign parameters and/or targeted content. According to some embodiments, the analysis and determination performed in Step 310 can be performed in a similar manner as discussed above respective the AI/ML and/or LLM mechanisms from Steps 304-306, discussed supra.

Thus, in Step 312, engine 200 can determine whether to modify the content campaign. That is, in some embodiments, when the determined score (e.g., metric value that indicates a predicted and/or realized effectiveness of the content campaign) is at or above the score threshold, engine 200 can proceed to Step 314. In Step 314, engine 200 can determine that the campaign, as is, inclusive of its implementation of the campaign parameters for disseminating the targeted content to a particular audience, is satisfactory, and at an effectiveness that does not warrant modification. Thus, Step 314 results in the implementation of the campaign, such that the existing targeted content is disseminated over a network according to its existing campaign parameters.

In some embodiments, when Step 312's determination results in engine 200 determining that the campaign will not be effective as it currently stands (e.g., the score is below the score threshold), then engine 200 can proceed to Step 316.

In Step 316, engine 200 can modify the content campaign, which can be in accordance with the campaign parameters and/or the associated content (e.g., targeted content). Accordingly, in some embodiments, this can include, but not be limited to, altering the targeted audience, altering the manner in which the audience is targeted (e.g., ad format and/or ad channel changes, as well as timing and mechanisms to use (e.g., provide on a webpage, send as an SMS message or email, and the like), changing the content (e.g., changing the content from a context of X to a context of Y, which can be tied to users' determined interests and/or conversions from previous campaigns, and the like), and the like, or some combination thereof. In some embodiments, engine 200 can store the information related to the modifications in database 108, discussed supra.

And, in Step 318, engine 200 can effectuate, cause, enable and/or facilitate the implementation and/or dissemination of the modified content campaign. Thus, according to some embodiments, the functionality enabled via engine 200 provides improved tools for DSPs to cultivate and disseminate ad campaigns for optimal impact on the intended audience, while maximizing exposure for the identified product(s). According to some embodiments, information related to any perceived, realized and/or measured performance gains/losses of the modified content campaign can fed back to engine 200 (and stored), which can restart the processing of Process 300 (e.g., re-execute Steps 302-318) based on the updated information learned from such iterative processing.

FIG. 6 is a schematic diagram illustrating a client device showing an example embodiment of a client device that may be used within the present disclosure. Client device 600 may include many more or less components than those shown in FIG. 6. However, the components shown are sufficient to disclose an illustrative embodiment for implementing the present disclosure. Client device 600 may represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 may optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 may be a liquid crystal display (LCD), gas plasma, light emitting diode (LED), or any other type of display used with a computing device. Display 654 may also include a touch sensitive screen arranged to receive input from an object such as a stylus or a digit from a human hand.

Keypad 656 may include any input device arranged to receive input from a user. Illuminator 658 may provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device 600 may through other components, provide other information that may be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores may be employed to store information that describes various capabilities of Client device 600. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 600.

Applications 642 may include computer executable instructions which, when executed by Client device 600, transmit, receive, and/or otherwise process audio, video, images, and enable telecommunication with a server and/or another user of another client device. Applications 642 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

1. A method comprising:
identifying, by a device, information related to an electronic data structure, the information comprising parameters and digital content;
determining, by a device, a set of previous data structures based on the information related to the data structure;
analyzing, by an artificial intelligence (AI) model executed by the device, the information related to the data structure based on information related to the set of previous data structures, the AI-model being a neural network comprising a configuration of nodes within a topology, each node corresponding to an activation function of the neural network that operates based on a connection to another node within the topology;
comparing, via the AI model, at least a portion of the information related to the data structure and at least a portion of the information related to the set of previous data structures per node via a series of activation functions;
determining, by the device, based on the AI analysis and comparison, a predicted performance of the data structure over a network; and
implementing, by the device, over the network, the data structure in accordance with the predicted performance, the implementation causing communication of the digital content over the network according to protocols defined by the predicted performance.

2. The method of claim 1, further comprising:
analyzing, via the AI model, the information related to the data structure; and
determining, based on the AI model analysis of the information related to the data structure, information related to the parameters and the digital content, wherein the analysis of the information related to the data structure based on the information related to the set of previous data structures is based on the determined information related to the parameters and the digital content.

3. The method of claim 1, further comprising:
determining, based on the predicted performance, to modify the information related to the data structure; and
modifying the data structure by modifying at least one of the parameters and the digital content.

4. The method of claim 3, wherein the implemented data structure is the modified data structure.

5. The method of claim 1, further comprising:
maintaining the information related to the data structure when the predicted performance is determined to satisfy a score threshold, wherein the implementation of the data structure is based on performance of the maintaining of the information related to the data structure.

6. The method of claim 1, wherein the parameters correspond to a manner in which the digital content of the data structure is disseminated over the network, the parameters comprising information related to a target audience.

7. The method of claim 1, wherein the AI model is a machine learning (ML) model.

8. The method of claim 1, wherein the AI model is a large language model (LLM).

9. The method of claim 1, wherein the data structure corresponds to at least one of a content campaign not yet launched and a content campaign currently being implemented on the network.

10. The method of claim 1, wherein the digital content comprises a set of digital advertisements.

11. A device comprising:
a processor configured to:
identify information related to an electronic data structure, the information comprising parameters and digital content;
determine a set of previous data structures based on the information related to the data structure;
analyze, by an artificial intelligence (AI) model, the information related to the data structure based on information related to the set of previous data structures, the AI-model being a neural network comprising a configuration of nodes within a topology, each node corresponding to an activation function of the neural network that operates based on a connection to another node within the topology;
compare, via the AI model, at least a portion of the information related to the data structure and at least a portion of the information related to the set of previous data structures per node via a series of activation functions;
determine, based on the AI analysis and comparison, a predicted performance of the data structure over a network; and
implement, over the network, the data structure in accordance with the predicted performance, the implementation causing communication of the digital content over the network according to protocols defined by the predicted performance.

12. The device of claim 11, wherein the processor is further configured to:
analyze, via the AI model, the information related to the data structure; and
determine, based on the AI model analysis of the information related to the data structure, information related to the parameters and the digital content, wherein the analysis of the information related to the data structure based on the information related to the set of previous data structures is based on the determined information related to the parameters and the digital content.

13. The device of claim 11, wherein the processor is further configured to:
determine, based on the predicted performance, to modify the information related to the data structure; and
modify the data structure by modifying at least one of the parameters and the digital content, wherein the implemented data structure is the modified data structure.

14. The device of claim 11, wherein the processor is further configured to:
maintain the information related to the data structure when the predicted performance is determined to satisfy a score threshold, wherein the implementation of the data structure is based on performance of the maintaining of the information related to the data structure.

15. The device of claim 11, wherein the parameters correspond to a manner in which the digital content of the data structure is disseminated over the network, the parameters comprising information related to a target audience.

16. A non-transitory computer-readable storage medium tangibly encoded with computer-executable instructions that when executed by a device, perform a method comprising:
identifying, by the device, information related to an electronic data structure, the information comprising parameters and digital content;
determining, by a device, a set of previous data structures based on the information related to the data structure;
analyzing, by an artificial intelligence (AI) model executed by the device, the information related to the data structure based on information related to the set of previous data structures, the AI-model being a neural network comprising a configuration of nodes within a topology, each node corresponding to an activation function of the neural network that operates based on a connection to another node within the topology;
comparing, via the AI model, at least a portion of the information related to the data structure and at least a portion of the information related to the set of previous data structures per node via a series of activation functions;
determining, by the device, based on the AI analysis and comparison, a predicted performance of the data structure over a network; and
implementing, by the device, over the network, the data structure in accordance with the predicted performance, the implementation causing communication of the digital content over the network according to protocols defined by the predicted performance.

17. The non-transitory computer-readable storage medium of claim 16, further comprising:
analyzing, via the AI model, the information related to the data structure; and
determining, based on the AI model analysis of the information related to the data structure, information related to the parameters and the digital content, wherein the analysis of the information related to the data structure based on the information related to the set of previous data structures is based on the determination of the information related to the parameters and the digital content.

18. The non-transitory computer-readable storage medium of claim 16, further comprising:
determining, based on the predicted performance, to modify the information related to the data structure; and
modifying the data structure by modifying at least one of the parameters and the digital content, wherein the implemented data structure is the modified data structure.

19. The non-transitory computer-readable storage medium of claim 16, further comprising:
maintaining the information related to the data structure when the predicted performance is determined to satisfy a score threshold, wherein the implementation of the data structure is based on performance of the maintaining of the information related to the data structure.

20. The non-transitory computer-readable storage medium of claim 16, wherein the parameters correspond to a manner in which the digital content of the data structure is disseminated over the network, the parameters comprising information related to a target audience.
